(19) United States
(12) Patent Application Publication
(10) Pub. No.: US 2009/0021669 A1
(43) Pub. Date: Jan. 22, 2009

(54) DISPLAY APPARATUS AND METHOD OF DRIVING THE SAME

(75) Inventors: Jun-Woo Lee, Anyang-si (KR); Seung-Hoon Lee, Yongin-si (KR); Hee-Seop Kim, Hwaseong-si (KR); Eun-Hee Han, Seoul (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/024,644

(22) Filed: Feb. 1, 2008

(30) Foreign Application Priority Data
Jul. 19, 2007 (KR) 10-2007-0072328

(51) Int. Cl. G09G 3/36

(52) U.S. Cl. 349/72

(57) ABSTRACT

A display apparatus displays an image in a normal driving mode at a low temperature where a response speed of a liquid crystal becomes lower than a critical value, and displays the image in an impulsive driving mode at a higher temperature where the response speed of the liquid crystal becomes higher than the critical value.

### CROSS-REFERENCE TO RELATED APPLICATION

This application claims priority from and the benefit of Korean Patent Application No. 10-2007-0072328, filed on Jul. 19, 2007, which is hereby incorporated by reference for all purposes as if fully set forth herein.

### BACKGROUND OF THE INVENTION

1. Field of the Invention

The present invention relates to a display apparatus and a method of driving the display apparatus. More particularly, the present invention relates to a display apparatus that may be operated in either a normal driving mode or an impulsive driving mode depending on an ambient temperature.

2. Discussion of the Background

In general, a display apparatus displays data processed in an information-processing device as images to allow a user to recognize the data displayed on the display apparatus. The display apparatus is small, lightweight, and has high resolution, so the display apparatus is widely used as a flat panel type display apparatus.

Recently, the liquid crystal display has become the most widely used flat panel display apparatus. A liquid crystal display displays images using liquid crystals that are realigned according to the intensity of an electric field. A liquid crystal display includes a liquid crystal display panel, and the liquid crystal display panel includes an array substrate on which thin film transistors are disposed, an opposite substrate facing the array substrate, and a liquid crystal layer interposed between the array substrate and the opposite substrate.

A liquid crystal display has a disadvantage in that image blurring may occur when displaying a fast moving picture due to the driving method of the liquid crystal display.

In order to prevent image blurring when displaying a moving picture, an impulsive driving method that inserts a black image or an intermediate gray image between display frames or a blinking method that turns a backlight unit on or off has been used. However, the backlight blinking method is cost prohibitive so the impulsive driving method is more widely applied than the backlight blinking method.

In order to apply the impulsive driving method to a liquid crystal display, the liquid crystal display may employ liquid crystals having a high response speed, and research and development have actively been performed to improve display quality of the fast moving pictures.

However, the response speed of the liquid crystals may decrease at low temperatures. For example, a medium-sized liquid crystal display, which may be applied to various electronic appliances, such as mobile phone, navigation, digital media broadcasting (DMB), etc., may be used outdoors, so the medium-sized liquid crystal display may be affected by the external temperature. When the response speed of the liquid crystals decreases due to a low external temperature, the on-off response speed of the liquid crystals for the impulsive driving method may be remarkably slowed, thus causing display quality degradation.

### SUMMARY OF THE INVENTION

The present invention provides a display apparatus that may provide improved display quality of a moving picture regardless of the temperature.

The present invention also provides a method of driving the above display.

Additional features of the invention will be set forth in the description which follows, and in part will be apparent from the description, or may be learned by practice of the invention.

The present invention discloses a display apparatus including a display panel, a temperature detector, a voltage comparator, and a driving mode selector. The display panel displays an image. The temperature detector detects an ambient temperature and outputs a signal corresponding to the detected ambient temperature. The comparator compares the signal output from the temperature detector with a reference value and outputs a control signal corresponding to the comparison result. The driving mode selector selects a normal driving mode or an impulsive driving mode in response to the control signal.

The present invention also discloses a method of driving a display apparatus in which an image is displayed. When an ambient temperature is detected and a signal corresponding to the ambient temperature is output, the signal is compared with a reference value. Based on the comparison result, a first control signal is output when the signal is higher than the reference value, and a second control signal is output when the signal is lower than the reference value. Then, a normal driving mode or an impulsive driving mode is selected in response to the first control signal or the second control signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a liquid crystal display according to an exemplary embodiment of the present invention.

FIG. 2 is an equivalent circuit diagram of one pixel shown in FIG. 1.

FIG. 3 is a plan view showing an assembly of a liquid crystal display panel of FIG. 1.

FIG. 4A is a circuit diagram showing a temperature detector having a diode-type temperature sensor according to an exemplary embodiment of the present invention.

FIG. 4B is a graph showing an output voltage of the temperature detector of FIG. 4A according to an ambient temperature.

FIG. 5A is a circuit diagram showing a temperature detector having a resistance-type temperature sensor according to another exemplary embodiment of the present invention.

FIG. 5B is a graph showing an output voltage of the temperature detector of FIG. 5A according to an ambient temperature.

FIG. 6 is a block diagram showing a liquid crystal display according to another exemplary embodiment of the present invention.

FIG. 7 is a circuit diagram showing a driving voltage generator and a temperature detector shown in FIG. 6.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to,” or “coupled to” another element or layer, it can be directly on, connected to, or coupled to the other element or layer or intervening elements or layers may be present. In contrast, when an element is referred to as being “directly on,” “directly connected to,” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

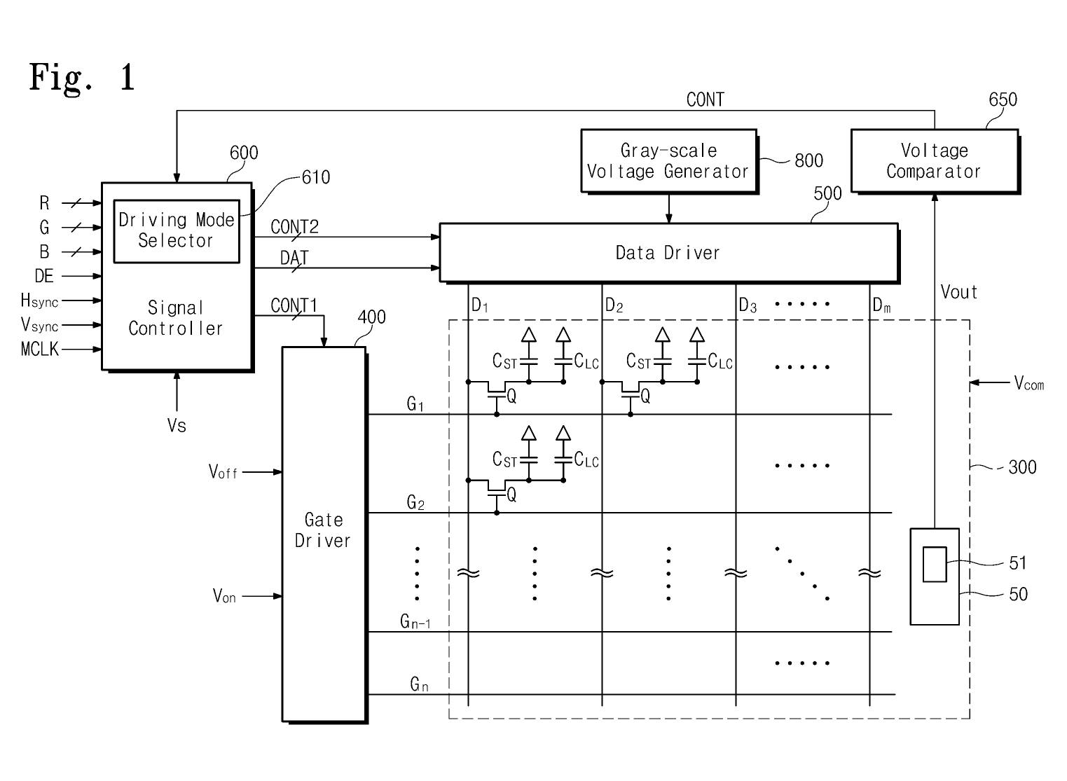

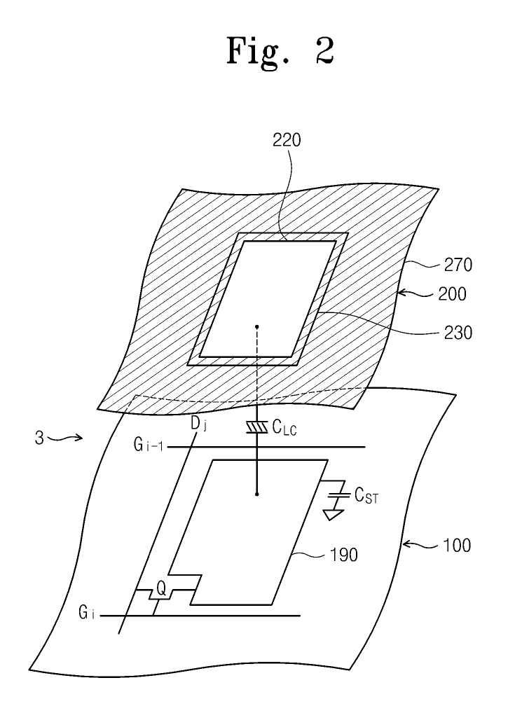

Referring to FIG. 1 and FIG. 2, a liquid crystal display includes a liquid crystal display panel assembly 300, a gate driver 400 connected to the liquid crystal display panel assembly 300, a data driver 500 connected to the liquid crystal display panel assembly 300, a gray-scale voltage generator 800 connected to the data driver 500, and a signal controller 600. Also, the liquid crystal display further includes a temperature detector 50 to detect an ambient temperature, a voltage comparator 650 to compare a voltage output from the temperature detector 50 with a critical voltage, and a driving mode selector 610 to determine a driving mode based on the compared result. In the present exemplary embodiment, a circuit configuration in which the driving mode selector 610 is positioned inside the signal controller 600 has been described, but the position of the driving mode selector 610 is not limited to the inside of the signal controller 600.

The liquid crystal display panel assembly 300 includes a plurality of display signal lines G1˜Gn and D1˜Dm and a plurality of pixels connected to the display signal lines G1˜Gn and D1˜Dm and arranged in column and row directions. Further, the liquid crystal display panel assembly 300 includes a lower substrate 100, an upper substrate 200 facing the lower substrate 100, and a liquid crystal layer 3 interposed between the lower and upper substrates 100 and 200. The liquid crystal layer 3 may include optically compensated bend liquid crystal.

The display signal lines G1˜Gn and D1˜Dm include a plurality of gate lines G1˜Gn to transmit a gate signal (scanning signal) and a plurality of data lines D1˜Dm to transmit a data signal. The gate lines G1˜Gn extend in a row direction and are parallel to each other, and the data lines D1˜Dm extend in a column direction and are parallel to each other.

Each pixel includes a switching element Q connected to a corresponding gate line and a corresponding data line, a liquid crystal capacitor C_{LC} connected to the switching element Q, and a storage capacitor C_{ST} connected to the switching element Q. If necessary, the storage capacitor C_{ST} may be omitted from the liquid crystal display panel assembly 600.

The switching element Q includes a thin film transistor arranged on the lower substrate 100, and the thin film transistor includes three terminals. The three terminals include a gate electrode connected to a corresponding gate line, a source electrode connected to a corresponding data line, and a drain electrode connected to the liquid crystal capacitor C_{LC} and a storage capacitor C_{ST}.

The liquid crystal capacitor C_{LC} is defined by a pixel electrode 190 disposed on the lower substrate 100 and a common electrode 270 disposed on the upper substrate 200, which serve as two electrodes of the liquid crystal capacitor C_{LC}, and the liquid crystal layer 3 that is interposed between the pixel electrode 190 and the common electrode 270 serves as dielectric substance. The pixel electrode 190 is connected to the switching element Q, and the common electrode 270 is disposed on the upper substrate 200 and receives a common voltage V_{COM}. Unlike the common electrode 270 shown in FIG. 2, the common electrode 270 may be disposed on the lower substrate 100, and at least one of the pixel electrode 190 and the common electrode 270 may have a linear or bar shape.

The storage capacitor C_{ST} is defined by a signal line (not shown) disposed on the lower substrate 100, the pixel electrode 190, and an insulating material interposed between the signal line and the pixel electrode 190. The signal line receives a constant voltage such as the common voltage V_{COM}. Alternatively, the storage capacitor C_{ST} may be defined by overlapping the pixel electrode 190 with a previous gate line positioned right above the pixel electrode 190 while interposing the insulating material between the pixel electrode 190 and the previous gate line.

In order to display colors, each pixel may display one primary color, that is, red, green, or blue color, (space division), or each pixel may alternately display the primary colors according to a time lapse (time division). Thus, desired colors may be recognized by combining the primary colors.

The upper substrate 200 includes a black matrix 220 (a region hatched by oblique lines in FIG. 2) disposed thereon to prevent light leakage, and the black matrix 220 is provided with an opening formed therethrough that corresponds to the pixel electrode 190 or a color filter 230.

As an example of the space division, a structure in which the color filter 230 displaying one of the primary colors is disposed on the upper substrate 200 corresponding to each pixel has been shown in FIG. 2. Unlike the color filter 230 shown in FIG. 2, the color filter 230 may be disposed on the lower substrate 100 at a position above or beneath of the pixel electrode 190.

At least one substrate of the lower and upper substrates 100 and 200 may be provided together with a polarizer (not shown) attached onto an outer surface of the substrate to polarize the light.

The gray-scale voltage generator 800 generates a pair of gray-scale voltages relating to a transmittance of the pixel. One of the pair of gray-scale voltages may have a positive value with respect to the common voltage V_{COM} and the other of the pair of gray-scale voltages may have a negative value with respect to the common voltage V_{COM}.

The gate driver 400 is connected to the gate lines G1˜Gn of the liquid crystal display panel assembly 300 to sequentially apply gate signals, each having a gate-on voltage Von and a gate-off voltage Voff, to the gate lines G1˜Gn. The gate driver 400 includes a plurality of integrated circuits.

The data driver 500 also includes a plurality of integrated circuits. The data driver 500 is connected to the data lines D1˜Dm of the liquid crystal display panel assembly 300 to apply a gray-scale voltage from the gray-scale voltage generator 800 to the pixel as a data signal.

The gate driver 400 and the data driver 500 may be directly on the liquid crystal display panel assembly 300 in the form of chips, or may be attached to the liquid crystal display panel assembly 300 after being mounted on a flexible printed circuit film (not shown). Further, the gate driver 400 and the data driver 500 may be directly on the liquid crystal display panel assembly 300 with the gate lines G1˜Gn and the data lines D1˜Dm.

The signal controller 600 controls the drive of the gate driver 400 and the data driver 500.

The temperature detector 50 includes at least one temperature sensor 51, and the temperature sensor 51 senses an ambient temperature and outputs an output voltage Vout corresponding to the sensed ambient temperature to the voltage comparator 650. The voltage comparator 650 compares the output voltage Vout with a critical voltage and outputs a control signal CONT to the driving mode selector 610. The driving mode selector 610 selects either a normal driving method or an impulsive driving method in response to the control signal CONT.

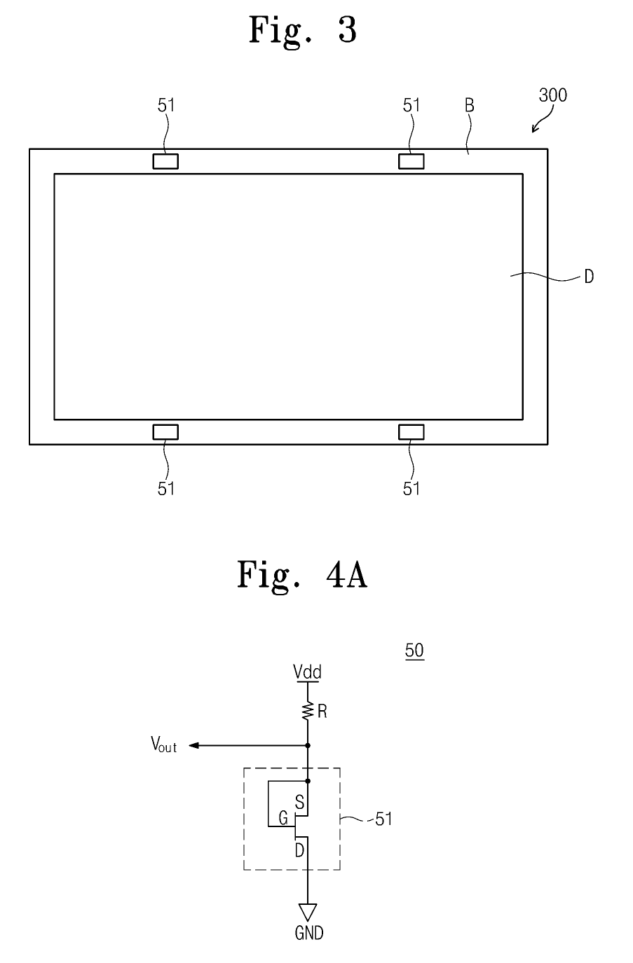

As shown in FIG. 3, the liquid crystal display panel assembly 300 is divided into a display area D, in which a plurality of pixels is disposed, and a non-display area B corresponding to an end portion of the liquid crystal display panel assembly 300. The non-display area B is covered by the black matrix 220. The temperature sensor 51 of the temperature detector 50 may be arranged in the non-display area B. In FIG. 3, two temperature sensors 51 are arranged at each of the upper and lower end portions of the liquid crystal display panel assembly 300, but the position and number of the temperature sensors 51 are not limited to the above-described embodiment. That is, temperature sensors 51 may additionally or alternatively be arranged at each of the left and right end portions of the liquid crystal display panel assembly 300.

Hereinafter, the display operation of the liquid crystal display will be described in detail.

The signal controller 600 receives input image signals R, G, and B, input control signals, such as a horizontal synchronizing signal Hsync, a vertical synchronizing signal Vsync, a main clock MCLK, and a data enable signal DE from an external graphics controller (not shown), and a driving control signal from the driving mode selector 610. The signal controller 600 processes the input image signals R, G, and B based on the input control signal and the driving control signal to operate the liquid crystal display panel assembly 300, and the signal controller 600 outputs the image data DAT. The signal controller 600 generates a gate control signal CONT1 and a data control signal CONT2, outputs the gate control signal CONT1 to the gate driver 400, and outputs the data control signal CONT2 and the image data DAT to the data driver 500.

The gate control signal CONT1 includes a scanning start signal to indicate the start of scanning and at least one clock signal to control the output timing of the gate-on voltage Von. The gate control signal CONT1 may further include an output enable signal to control the output duration of the gate-on signal Von.

The data control signal CONT2 includes a horizontal synchronizing start signal to begin data transmission of one pixel row, a load signal instructing to apply data voltages to the data lines D1˜Dm, a reverse signal to reverse the polarity of the data voltages with respect to the common voltage V_{COM} (hereinafter, “the polarity of the data voltages with respect to the common voltage V_{COM}” will be referred to as “a polarity of data voltage”), and a data clock signal.

The data driver 500 successively receives the image data DAT for a row of the pixels in response to the data control signal CONT2 from the signal controller 600, converts the image data DAT into analog data voltages from the gray-scale voltages from the gray-scale voltage generator 800, and applies the data voltages to the data lines D1˜Dm.

The gate driver 400 sequentially applies the gate-on voltage Von to the gate lines G1˜Gn in response to the gate control signal CONT1 received from the signal controller 600, thereby turning on the switching elements Q connected thereto. The data voltages applied to the data lines D1˜Dm are applied to the corresponding pixel through the activated switching elements Q.

The difference between the data voltage applied to the pixel and the common voltage V_{COM} is represented as a voltage across the liquid crystal capacitor C_{LC}, namely, a pixel voltage. The orientation of liquid crystal molecules in the liquid crystal layer 3 depends on the magnitude of the pixel voltage, and varying the magnitude of the pixel voltage permits varying amounts of light to pass through the liquid crystal layer 3 to display an image.

The gate driver 400 and the data driver 500 repeatedly perform the same operation during every horizontal period (which is denoted by 1H and equal to one period of the horizontal synchronizing signal Hsync and a gate clock signal). All of the gate lines G1˜Gn are sequentially supplied with the gate-on voltage Von during a frame, thereby applying the data voltages to all pixels. When the next frame starts after finishing one frame, the polarity of the data voltages is reversed with respect to that of the previous frame (which is referred to as “frame inversion”) by transmitting a reverse control signal to the data driver 500. The reverse control signal may be also controlled such that the polarity of the data voltages flowing along a data line in one frame are reversed (for example, line inversion and dot inversion), or the polarity of the data voltages in one packet are reversed (for example, column inversion and dot inversion).

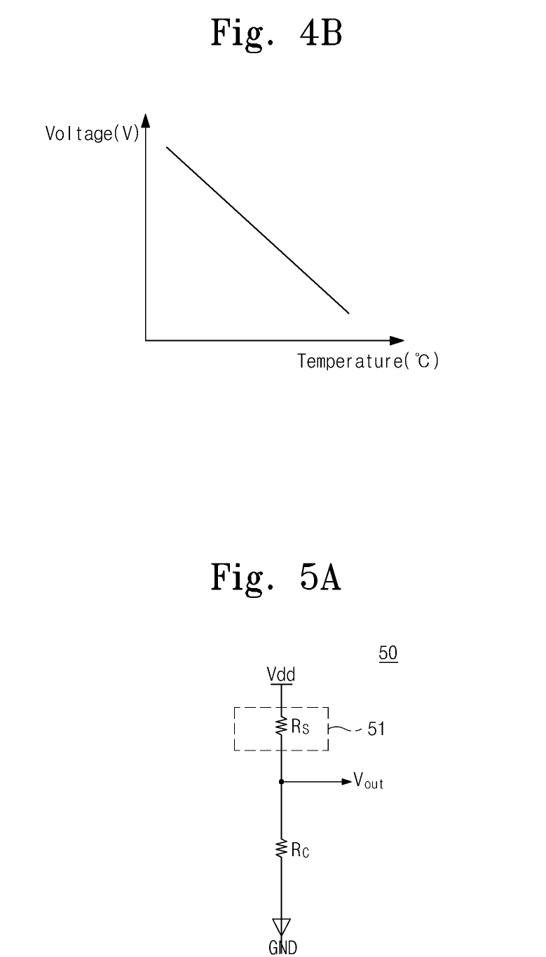

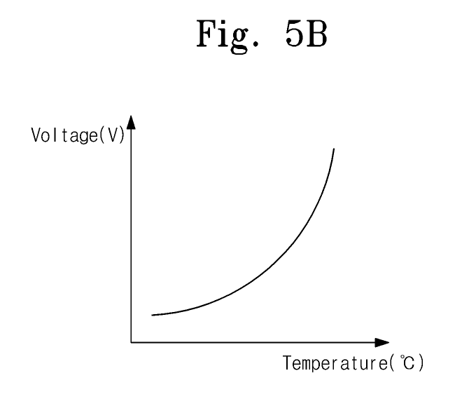

Hereinafter, the temperature detector, the display apparatus having the temperature detector, and the driving method of the display apparatus will be described in detail with reference to FIG. 4A, FIG. 4B, FIG. 5A, and FIG. 5B.

The temperature detector 50 disposed in the non-display area B of the liquid crystal display panel assembly 30 includes the temperature sensor 51. According to the electric connection structure of the gate, source, and drain electrodes of the thin film transistor, the temperature sensor 51 may operate as a diode shown in FIG. 4A. Also, the temperature sensor 51 may operate as a variable resistance shown in FIG. 5A.

First, an exemplary embodiment that the temperature sensor 51 is operated as a diode-type temperature sensor will be described with reference to FIG. 4A and FIG. 4B.

Referring to FIG. 4A, the temperature sensor 51 includes one thin film transistor. The gate electrode G and the source electrode S are connected to each other, and the drain electrode D is connected to a ground terminal GND. When the gate electrode G and the source electrode S are connected to each other as the above-described, the temperature sensor 51 operates as a diode.

A voltage Vout output from an output terminal connected to the source electrode S of the temperature sensor 51 is obtained by equation 1 as follows.

In FIG. 4A, R indicates a fixed resistance, and Vdd indicates an input voltage.

Vout=Vdd−RI_{D} Equation 1

In equation 1, I_{D} represents a current flowing through the temperature sensor 51. Since a voltage between the gate electrode G and the drain electrode D is equal to a voltage between the source electrode S and the drain electrode D, I_{D} is defined by equation 2 as follows.

$${I}_{D} = {μ}_{n} {C}_{g} \frac{W}{L} ( \frac{{Vout}^{2}}{2} - VthVout ) \qquad Equation 2$$

In equation 2, μₙ, represents the electron mobility, Cg represents the capacitance between the gate and drain electrodes G and D of the temperature sensor 51, W represents the channel width of the temperature sensor 51, L represents a channel length of the temperature sensor 51, and Vth represents the threshold voltage.

The electron mobility μₙ is obtained by equation 3 as follows.

$${μ}_{n} = {μ}_{o} \frac{NckT}{n} e - \frac{Ea}{kT} \qquad Equation 3$$

In equation 3, μₒ represents the extended-state electron mobility, Nc represents the state density at mobility edge, k represents the Boltzmann constant, T represents the temperature (K), n represents the total electron density, and Ea represents the activation energy.

With reference to equations 1, 2, and 3, the output voltage Vout output through the output terminal of the temperature sensor 51 is varied according to temperature.

The output voltage Vout output through the output terminal of the temperature sensor 51 as shown in FIG. 4A is linearly reduced in accordance with an increase of the temperature as shown in FIG. 4B.

When using the diode-type temperature sensor 51, the output voltage Vout becomes higher than the critical voltage at the critical temperature. Below the critical temperature, it is difficult to apply the impulsive driving method because the response speed of the liquid crystals slows below the critical temperature. To the contrary, at temperatures above the critical temperature, the output voltage Vout decreases as compared with the critical voltage.

The response speed of the liquid crystals, the critical temperature, and the critical voltage depend on the kind of liquid crystal.

For instance, in an impulsive driving mode of 120 Hz, when a temperature corresponding to an on-off response speed of the liquid crystals of approximately 8 ms or more is the critical temperature, the temperature sensor 51 outputs the critical voltage as its output voltage Vout at the critical temperature. In this case, since one frame is maintained for about 8 ms, the on-off response speed of the liquid crystal may be become longer than the duration of one frame. At this time, when the impulsive driving method is applied to insert a black image or an intermediate gray image between the images, the brightness may deteriorate because the liquid crystals are not aligned sufficiently. However, the critical value of the on-off response speed of the liquid crystals, the critical temperature, and the critical voltage are not limited to the above-described 8 ms, and the critical value, the critical temperature, and the critical voltage may vary according to the response speed of the liquid crystals, the ambient temperature suitable for the impulsive driving conditions for the specific kind of liquid crystal, or the driving method of the display apparatus.

The output voltage Vout output from the temperature sensor 51 of the temperature detector 50 is applied to the voltage comparator 650. The voltage comparator 650 compares the output voltage Vout with the critical voltage. When the output voltage Vout is higher than the critical voltage, the voltage comparator 650 provides a first control signal to the driving mode selector 610, and the voltage comparator 650 provides a second control signal to the driving mode selector 610 when the output voltage Vout is lower than the critical voltage.

The driving mode selector 610 selects either the normal driving method or the impulsive driving method in response to the first or second control signal from the voltage comparator 650 and outputs the driving control signal to the signal controller 600. In the present exemplary embodiment, the driving mode selector 610 selects the normal driving method that displays only desired images in response to the first control signal, and selects the impulsive driving method that inserts the black image or the intermediate gray image into between the desired images in response to the second control signal.

Next, an exemplary embodiment in which the temperature sensor 51 operates as a resistance-type temperature sensor will be described with reference to FIG. 5A and FIG. 5B.

Referring to FIG. 5A, the temperature sensor 51 includes a resistor Rs having a first terminal to which the input voltage Vdd is applied and a second terminal connected to an output terminal. Also, the temperature sensor 51 further includes a resistor Rc having a fixed resistance value. A first terminal of the resistor Rc is connected to the second terminal of the resistor Rₛ and the output terminal of the temperature sensor 51, and a second terminal of the resistor Rc is connected to a ground terminal GND.

When the temperature sensor 51 is the resistance-type (Rs), a voltage Vout output from the output terminal satisfies equation 4 as follows.

$$Vout = \frac{Rc}{Rs + Rc} Vdd \qquad Equation 4$$

In equation 4, Rs satisfies equation 5 as follows.

$$Rs = ρ \frac{L}{WD} \qquad Equation 5$$

In equation 5, ρ is obtained by equation 6 as follows.

$$σ = ne {μ}_{n} = \frac{1}{ρ} \qquad Equation 6$$

In equation 6, e represents the charge amount of carrier. Since the electron mobility (μₙ) is represented as in equation 3, the output voltage Vout output from the output terminal varies according to temperature.

The output voltage Vout output through the output terminal of the temperature sensor 51 as shown in FIG. 5A increases with temperature as shown in FIG. 5B.

When using the resistance-type temperature sensor 51, the output voltage Vout becomes lower than the critical voltage at the critical temperature. Below the critical temperature, it is difficult to apply the impulsive driving method because the response speed of the liquid crystals slows below a critical value. To the contrary, when the temperature is above the critical temperature, the response speed of the liquid crystals is above the critical value, the output voltage Vout increases as compared with the critical voltage.

In the present exemplary embodiment, the critical value of the on-off response speed of the liquid crystals, the critical temperature, and the critical voltage may vary due to the response speed of the liquid crystals and the ambient temperature suitable for the impulsive driving conditions according to the kind of liquid crystal or the driving method of the display apparatus.

The output voltage Vout output from the temperature sensor 51 of the temperature detector 50 is applied to the voltage comparator 650. The voltage comparator 650 compares the output voltage Vout with the critical voltage. When the output voltage Vout is lower than the critical voltage, the voltage comparator 650 provides a third control signal to the driving mode selector 610, and the voltage comparator 60 provides a fourth control signal to the driving mode selector 610 when the output voltage Vout is higher than the critical voltage.

The driving mode selector 610 selects either the normal driving method or the impulsive driving method in response to the third or fourth control signal from the voltage comparator 650 and outputs the driving control signal corresponding to the selected driving method to the signal controller 600. In the present exemplary embodiment, the driving mode selector 610 selects the normal driving method that displays only desired images in response to the third control signal, and selects the impulsive driving method that inserts the black image or the intermediate gray image between the desired images in response to the fourth control signal.

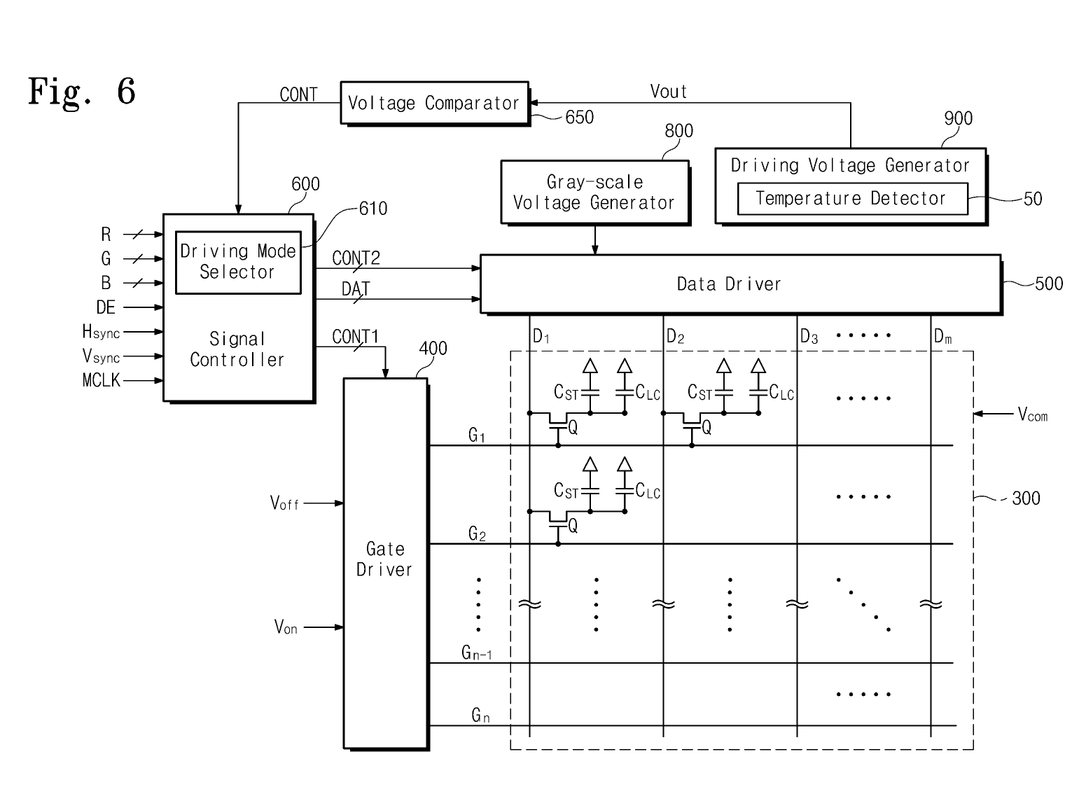

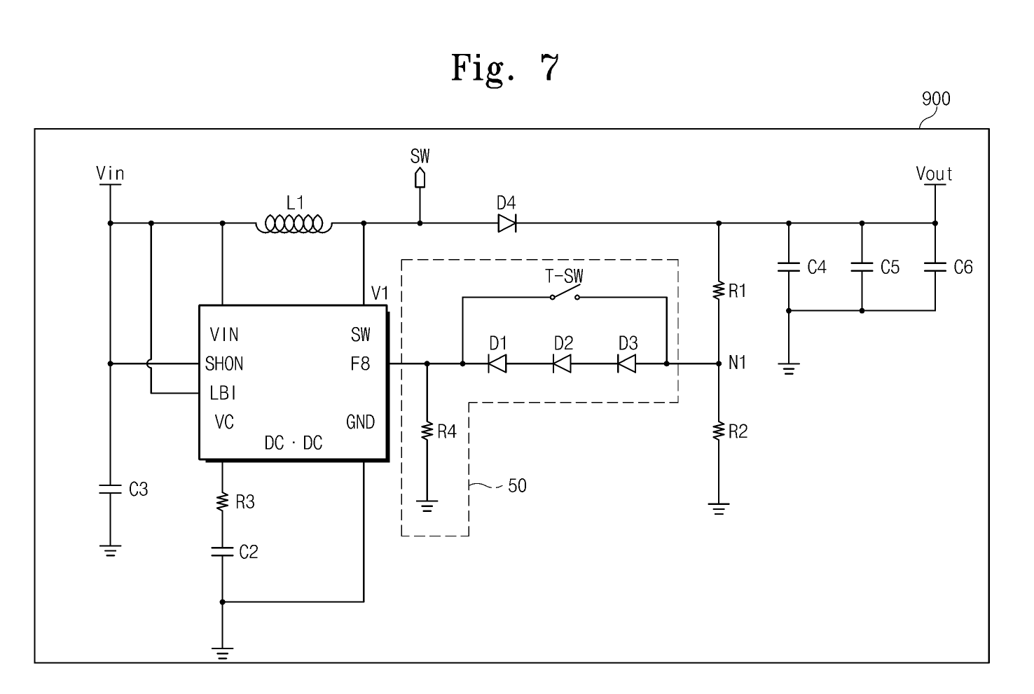

Hereinafter, a display apparatus and a method of driving the display apparatus according another exemplary embodiment of to the present invention will be described in detail with reference to FIG. 6 and FIG. 7.

FIG. 6 is a block diagram showing a liquid crystal display according to another exemplary embodiment of the present invention, and FIG. 7 is a circuit diagram showing a driving voltage generator and a temperature detector shown in FIG. 6.

Referring to FIG. 6 and FIG. 7, a liquid crystal display includes a liquid crystal display panel assembly 300, a gate driver 400 connected to the liquid crystal display panel assembly 300, a data driver 500 connected to the liquid crystal display panel assembly 300, a gray-scale voltage generator 800 connected to the data driver 500, a signal controller 600, and a driving voltage generator 900. The driving voltage generator 900 further includes a temperature detector 50 that is necessary to determine a driving method according to an ambient temperature. Also, the liquid crystal display further includes a voltage comparator 650 to compare a voltage output from the temperature detector 50 with a critical voltage and a driving mode selector 610 to determine the driving mode based on the compared result.

In the present exemplary embodiment, a circuit configuration of the liquid crystal display is same as that of the liquid crystal display shown in FIG. 1 except a circuit configuration that the temperature detector 50 is positioned inside the driving voltage generator 900.

The driving voltage generator 900 generates various driving voltages that are necessary to drive the liquid crystal display, such as a gate-on voltage Von, a gate-off voltage Voff, a driving reference voltage Vdd, etc.

The temperature detector 50 is positioned inside the driving voltage generator 900 and includes diodes D1, D2, and D3 and a thermal switch T-SW connected in parallel to the diodes D1, D2, and D3.

The thermal switch T-SW is closed at a temperature equal to or larger than the critical temperature, and is opened at a temperature smaller than the critical temperature. The critical temperature is defined as the temperature at which the liquid crystals have a response speed that is sufficient to perform the impulsive driving.

When the ambient temperature of the liquid crystal display is equal to or larger than the critical temperature, the thermal switch T-SW is closed, so that a voltage drop by the diodes D1, D2, and D3 does not occur. Thus, the driving voltage generator 900 outputs a constant voltage Vout through the output terminal thereof.

However, when the ambient temperature decreases below the critical temperature, the thermal switch S-TW is opened, thereby causing the voltage drop by the diodes D1, D2, and D3.

The diodes D1, D2, and D3 of the temperature detector 50 have different voltage drop characteristics according to the ambient temperature. That is, assuming that a current flowing through the diodes D1, D2, and D3 is about 0.1 mA, the diodes D1, D2, and D3 cause a voltage drop of about 0.4 volts at a temperature of about 85 degrees Celcius and cause a voltage drop of about 0.6 volts at a temperature of about −30 degrees Celcius.

In general, the driving voltage generator 900 is designed to have a constant voltage level at a node N1. Accordingly, when the voltage drop occurs due to the diodes D1, D2, and D3, the output voltage Vout of the driving voltage generator 900 increases in order to constantly maintain the voltage at the node N1 by equation 7 as follows.

$$Vn = ( \frac{R 2}{R 1 + R 2} ) Vout \qquad Equation 7$$

The voltage comparator 650 compares the output voltage Vout output from the driving voltage generator 900 with the critical voltage. Based on the comparison result, when the output voltage Vout is equal to or lower than the critical voltage, the voltage comparator 650 outputs a fifth control signal, and the voltage comparator 650 outputs a sixth control signal when the output voltage Vout is higher than the critical voltage. The critical voltage is defined as the output voltage Vout that is output from the driving voltage generator 900 at the critical temperature where the thermal switch S-TW of the temperature detector 50 is changed from the close state to the open state.

The driving mode selector 610 selects the impulsive driving mode in response to the fifth control signal, selects the normal driving mode in response to the sixth control signal, and outputs a driving control signal corresponding to the selected driving mode to the signal controller 610.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A display apparatus, comprising:
a display panel to display an image;
a temperature detector to detect an ambient temperature and output a signal corresponding to the detected ambient temperature;
a comparator to compare the signal output from the temperature detector with a reference value and to output a control signal corresponding to the comparison result; and
a driving mode selector to select either a normal driving mode or an impulsive driving mode in response to the control signal.

2. The display apparatus of claim 1, wherein the signal is a first voltage, and the reference value is a second voltage

3. The display apparatus of claim 2, wherein the display panel comprises an optically compensated bend mode liquid crystal.

4. The display apparatus of claim 2, wherein the temperature detector comprises a thin film transistor arranged in a peripheral area of the display panel.

5. The display apparatus of claim 4, wherein the temperature detector further comprises a fixed resistance connected to a reference voltage, and
wherein the fixed resistance, a gate electrode of the thin film transistor, a source electrode of the thin film transistor, and an output terminal of the temperature detector are connected to each other at a first node, and a drain electrode of the thin film transistor is grounded.

6. The display apparatus of claim 4, wherein the voltage comparator outputs a first control signal when the first voltage output from the temperature detector is higher than the second voltage, and outputs a second control signal when the first voltage output from the temperature detector is lower than the second voltage.

7. The display apparatus of claim 6, wherein the driving mode selector selects the normal driving mode in response to the first control signal, and selects the impulsive driving mode in response to the second control signal.

8. The display apparatus of claim 4, wherein the temperature detector further comprises a fixed resistance,
wherein a source electrode of the thin film transistor is connected to a reference voltage,
wherein a drain electrode of the thin film transistor, a first terminal of the fixed resistance, and an output terminal of the temperature detector are connected to each other at a first node, and
wherein a second terminal of the fixed resistance is grounded.

9. The display apparatus of claim 8, wherein the voltage comparator outputs a first control signal when the first voltage output from the temperature detector is lower than the second voltage, and outputs a second control signal when the voltage output from the temperature detector is higher than the second voltage.

10. The display apparatus of claim 9, wherein the driving mode selector selects the normal driving mode in response to the first control signal, and selects the impulsive driving mode in response to the second control signal.

11. The display apparatus of claim 2, further comprising a driving voltage generator inside which the temperature detector is positioned,
wherein the temperature detector comprises:
a thermal switch that is closed at a temperature equal to or higher than a critical temperature and open at a temperature lower than the critical temperature; and
a diode that is connected in parallel with the thermal switch.

12. The display apparatus of claim 11, wherein the driving voltage generator outputs a third voltage at the temperature equal to or higher than the critical temperature, and outputs a fourth voltage at the temperature lower than the critical temperature.

13. The display apparatus of claim 12, wherein the voltage comparator outputs a first control signal in response to the third voltage, and outputs a second control signal in response to the fourth voltage.

14. The display apparatus of claim 13, wherein the driving mode selector selects the impulsive driving mode in response to the first control signal, and selects the normal driving mode in response to the second control signal.

15. A method of driving a display apparatus, comprising:
displaying an image;
detecting an ambient temperature;
outputting a signal corresponding to the ambient temperature;
comparing the signal with a reference value;
outputting a first control signal when the signal is higher than the reference value, and outputting a second control signal when the voltage is lower than the critical voltage; and
selecting either a normal driving mode or an impulsive driving mode in response to the first control signal or the second control signal.

16. The method of claim 15, wherein the signal is a first voltage, and the reference value is a second voltage.

17. The method of claim 16, wherein the display apparatus is operated in an optically compensated bend mode when displaying the image.

18. The method of claim 17, wherein the selecting of the driving mode comprises;
selecting the normal driving mode in response to the first control signal; and
selecting the impulsive driving mode in response to the second control signal.

19. The method of claim 15, wherein the selecting of the driving mode comprises;
selecting the impulsive driving mode in response to the first control signal; and
selecting the normal driving mode in response to the second control signal.
